(19) United States
(12) Patent Application Publication
(10) Pub. No.: US 2025/0283569 A1
(43) Pub. Date: Sep. 11, 2025

(54) CIRCUMFERENTIALLY CONTINUOUS, FIRE RESISTANT, MULTILAYER THERMAL SLEEVE

(71) Applicant: FEDERAL-MOGUL POWERTRAIN LLC, Northville, MI (US)

(72) Inventors: SEAN DONOVAN O'HARA, NORTHVILLE, MI (US); KAMEL FENNELL, JR., PLYMOUTH MEETING, PA (US); XIAODAN QIU, PHOENIXVILLE, PA (US); LAMAR TONEY, NORTHVILLE, MI (US)

(21) Appl. No.: 19/071,496

(22) Filed: Mar. 5, 2025

Related U.S. Application Data
(60) Provisional application No. 63/562,016, filed on Mar. 6, 2024.

(51) Int. Cl. F16L 57/04; D06N 3/00; D06N 3/12

(52) U.S. Cl. CPC F16L 57/04; D06N 3/0015; D06N 3/0063; D06N 3/128; D06N 2201/08; D06N 2203/066; D06N 2209/067; D06N 2209/0823

(57) ABSTRACT

A sleeve has a textile wall having a circumferentially continuous outer surface extending along a longitudinal axis between opposite open ends. The textile wall includes heat-resistant multifilament yarn and an impervious coating extending about the outer surface of the textile wall to allow the sleeve to withstand heat up to 1000° C. or greater for a continuous duration of 20 minutes or more. The impervious coating includes one of a silicone ingredient, a silicone-based ingredient, a liquid silicone rubber ingredient, a polytetrafluoroethylene ingredient, or a polyurethane ingredient, and includes at least one of carbon black pigmentation and iron oxide pigmentation impregnated therein.

### CROSS-REFERENCE TO RELATED APPLICATION

This application claims the benefit of U.S. Provisional Application Ser. No. 63/562,016, filed Mar. 6, 2024, which is incorporated herein by reference in its entirety.

### BACKGROUND OF THE INVENTION

### 1. Technical Field

This invention relates generally to textile sleeves for protecting an elongate member contained therein, and more particularly to circumferentially continuous, axially and radially stretchable, fire suppressing, thermally insulating sleeves.

### 2. Related Art

It is known to contain elongate members, such as wires, wire harnesses, cables and fluid conveying conduits of various types in circumferentially continuous, tubular walled sleeves to provide protection to the elongate members against impact and abrasion, fluid and external thermal affects. However, there remains a need for protective sleeving that can provide fire suppressant protection to an elongate member contained therein, while also be able to thermally insulate the elongate member and attain a low profile, having a conformed fit about the elongate member and connectors thereof so as to not be cumbersome, unsightly and bulky, while also being impervious to dust, particles and smoke and being flexible so as to be able to be routed along a serpentine path, such as along bends of the elongate member, without becoming wrinkled. There is a further need to have a protective sleeve that is able to protect a fluid conveying conduit of an electric vehicle battery system to prevent the fluid from evaporating, thereby enabling the vehicle to remain drivable under power from the battery system for at least 20 minutes of exposure to flame of 1000° C. or higher.

### SUMMARY OF THE INVENTION

One object of the disclosure is to provide a textile sleeve that provides fire suppressant, thermally insulative protection to an elongate member contained therein.

Another object of the disclosure is to provide a radially and axially stretchable knit sleeve having an outer impervious coating that provides fire suppressant, thermally insulative protection to an elongate member contained therein.

Another object of the disclosure is to provide protection to a fluid conveying coolant conduit of an electric vehicle battery pack via a coated textile sleeve to enable the battery pack to supply power to the electric vehicle for 20 minutes or more upon experiencing a continuous temperature of 1000° C.

Another object of the disclosure is to provide a coated textile sleeve that is able to bend along a coolant conduit and fit about any connector attached to the coolant conduit.

Another object of the disclosure is to provide a coated textile sleeve that is able to conform about a coolant conduit an electric vehicle battery system in snug fitting relation and about any connector attached to the coolant conduit.

In accordance these and other objects, a sleeve for providing protection to an elongate member, such as a bus-bar or coolant conduit of a battery pack of an electric vehicle is provided. The sleeve has a textile wall having a circumferentially continuous outer surface extending along a longitudinal axis between opposite open ends. The textile wall is formed at least in part with multifilament flame-resistant yarn. The textile structure of the textile wall is stretchable axially and radially, thereby allowing the textile wall to easily flex and be easily assembled into close conforming, wrinkle-free relation about the elongate member regardless of the number of bends and shape of the outer contour of an outer surface of the elongate member. An impervious coating is provided to extend about the outer surface of the textile wall to prevent the ingress and penetration of dust, particles, smoke through the knit wall, and to enhance the flame resistance and thermal insulating properties of the sleeve, wherein the impervious coating can withstand heat up to 1000° C. or greater for a continuous duration of 20 minutes or more. The impervious coating is stretchable axially and radially to allow the underlying textile wall to remain stretchable, thereby facilitating the formation of a wrinkle-free, snug conforming fit of the sleeve about the elongate member. The impervious coating includes one of a silicone ingredient, a silicone-based ingredient, a liquid silicone rubber ingredient, a polytetrafluoroethylene ingredient, or a polyurethane ingredient, wherein the impervious coating layer includes at least one of carbon black pigmentation and iron oxide pigmentation impregnated therein.

In accordance with another aspect of the invention, the impervious coating is bonded directly to the outer surface of the textile wall.

In accordance with another aspect of the invention, the impervious coating includes a fire retardant.

In accordance with another aspect of the invention, the fire retardant in the impervious coating is zinc borate.

In accordance with another aspect of the invention, the carbon black and/or iron oxide make up between 0.01-10.0% by weight content of the impervious coating.

In accordance with another aspect of the invention, the fire retardant makes up between 1.0-20.0% by weight content of the impervious coating.

In accordance with another aspect of the invention, the content of silicone in the impervious coating is between 80.0-99.0% by weight content of the impervious coating.

In accordance with another aspect of the invention, the impervious coating is a single layer having a thickness between 0.1-10 mm.

In accordance with another aspect of the invention, the impervious coating includes a plurality of separately formed layers, with each layer having a thickness between 0.1-10 mm.

In accordance with another aspect of the invention, the layer(s) of the impervious coating are cured separately from one another.

In accordance with another aspect of the invention, the multifilament flame-resistant yarn extends in a lengthwise direction generally or substantially (meaning it may not be perfectly parallel, but closely resembles a parallel relation to the naked eye of an observer, thereby being without about 5 degrees from true parallel) parallel to the longitudinal axis and in a circumferential weft direction about the longitudinal axis.

In accordance with another aspect of the invention, the flame-resistant yarn is a mineral yarn.

In accordance with another aspect of the invention, the mineral yarn can be provided as at least one of fiberglass, silica, and basalt.

In accordance with another aspect of the invention, the entirely of the textile wall can be made with flame-resistant yarn.

In accordance with another aspect of the invention, the sleeve consist of the textile wall and the impervious coating.

In accordance with another aspect of the invention, a method of constructing a sleeve for providing thermal protection to an elongate member, such as a bus-bar or fluid conveying conduit, of an electric vehicle battery pack is provided. The method includes interlacing multifilament flame-resistant yarn to form a textile wall having a circumferentially continuous outer surface extending along a longitudinal axis between opposite open ends. Further, bonding an impervious coating to the outer surface of the textile wall, with the impervious coating including one of a silicone ingredient, a silicone-based ingredient, a liquid silicone rubber ingredient, a polytetrafluoroethylene ingredient, or a polyurethane layer ingredient, wherein the coating layer includes at least one of carbon black pigmentation impregnated therein and iron oxide pigmentation impregnated therein.

In accordance with another aspect of the invention, the method can further include providing the multifilament flame-resistant yarn from at least one of fiberglass, silica, and basalt.

In accordance with another aspect of the invention, the method can further include forming the entirety of the textile wall from the mineral yarn.

In accordance with another aspect of the invention, the method can further include forming the textile wall including shrinkable yarn, wherein the shrinkable yarn is configured to constrict the continuous outer surface from a first diameter to a reduced second diameter, thereby allowing the sleeve to be shrunk into a snug fit about the elongate member.

In accordance with another aspect of the invention, the method can further include forming the textile wall having a plurality of layers arranged in overlying relation with one another.

In accordance with another aspect of the invention, the method can further include forming the plurality of layers of the textile wall being connected to one another.

In accordance with another aspect of the invention, the method can further include forming the plurality of layers of the textile wall in a continuous interlacing operation.

In accordance with another aspect of the invention, the method can further include forming the plurality of layers of the textile wall including different yarn types from one another to provide the separate layers having different protective properties from one another.

In accordance with another aspect of the invention, the method can further include forming the plurality of layers of the textile wall in at least one of a knitting process, weaving process, or braiding process.

In accordance with another aspect of the invention, the method can further include interlacing the multifilament flame-resistant yarn to form the textile wall in a knitting process.

In accordance with another aspect of the invention, the method includes providing the carbon black and/or iron oxide making up between 0.01-10.0% by weight content of the impervious coating.

In accordance with another aspect of the invention, the method includes providing the fire retardant making up between 1.0-20.0% by weight content of the impervious coating.

In accordance with another aspect of the invention, the method includes providing the content of silicone in the impervious coating making up between 80.0-99.0% by weight content of the impervious coating.

In accordance with another aspect of the invention, the method includes providing the impervious coating as a single layer having a thickness between 0.1-10 mm.

In accordance with another aspect of the invention, the method includes providing the impervious coating as a plurality of layers, with each layer having a thickness between 0.1-10 mm.

In accordance with another aspect of the invention, the method includes curing each, whether a single layer or a plurality of layers, separately from one another.

In accordance with another aspect of the invention, the method includes curing each layer of the impervious coating at a temperature range of about 100-300° C. for a duration between about 1-30 min.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a perspective view of a motor vehicle having a textile sleeve constructed in accordance with one aspect of the disclosure disposed about an electric vehicle battery elongate member to be protected;

FIG. 2 is an enlarged, fragmentary schematic perspective view of the textile sleeve in accordance with one aspect of the disclosure shown disposed about the elongate member to be protected;

FIG. 3 is an enlarged schematic cross-sectional view taken generally along the line 3-3 of FIG. 2;

FIG. 4 is an enlarged, fragmentary schematic perspective view of a textile sleeve constructed in accordance with another aspect of the disclosure shown disposed about the elongate member to be protected;

FIG. 5 is an enlarged schematic cross-sectional view taken generally along the line 5-5 of FIG. 4;

FIG. 6A is a schematic plan view of a textile layer of the sleeve illustrating the textile layer being woven in accordance with one embodiment of the disclosure;

FIG. 6B is a view similar to FIG. 6A illustrating the textile layer being braided in accordance with another embodiment of the disclosure; and

FIG. 6C is a view similar to FIG. 6A illustrating the textile layer being knitted in accordance with yet another embodiment of the disclosure.

### DETAILED DESCRIPTION OF PREFERRED EMBODIMENTS

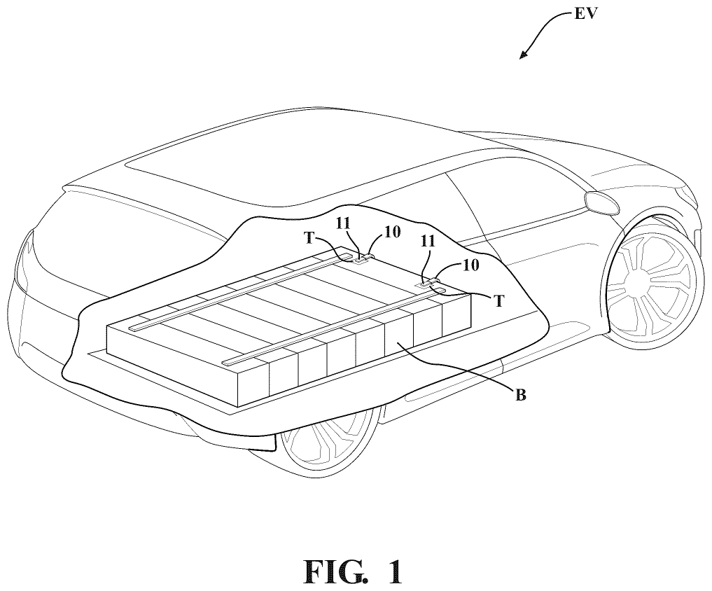

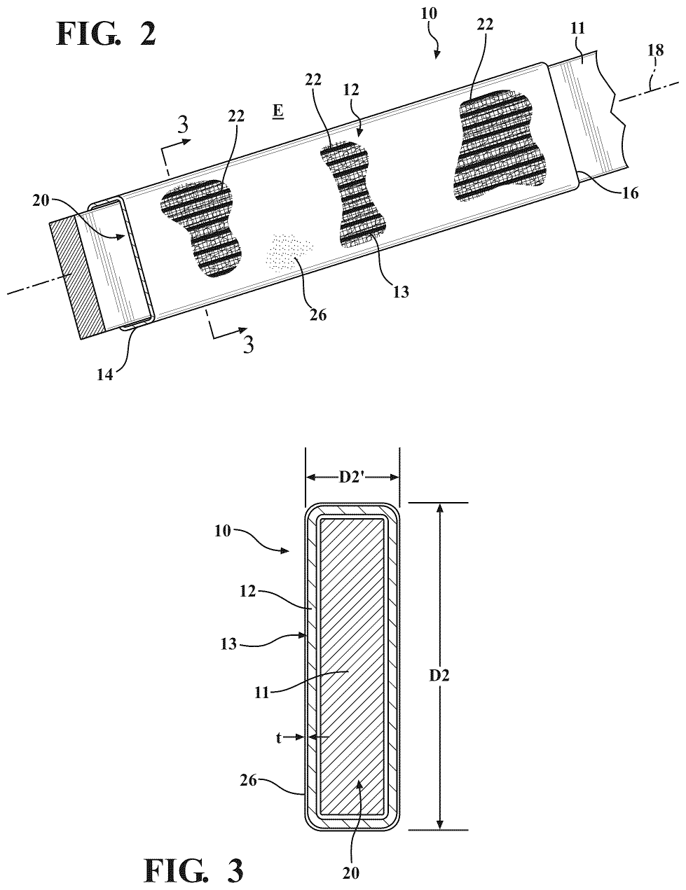

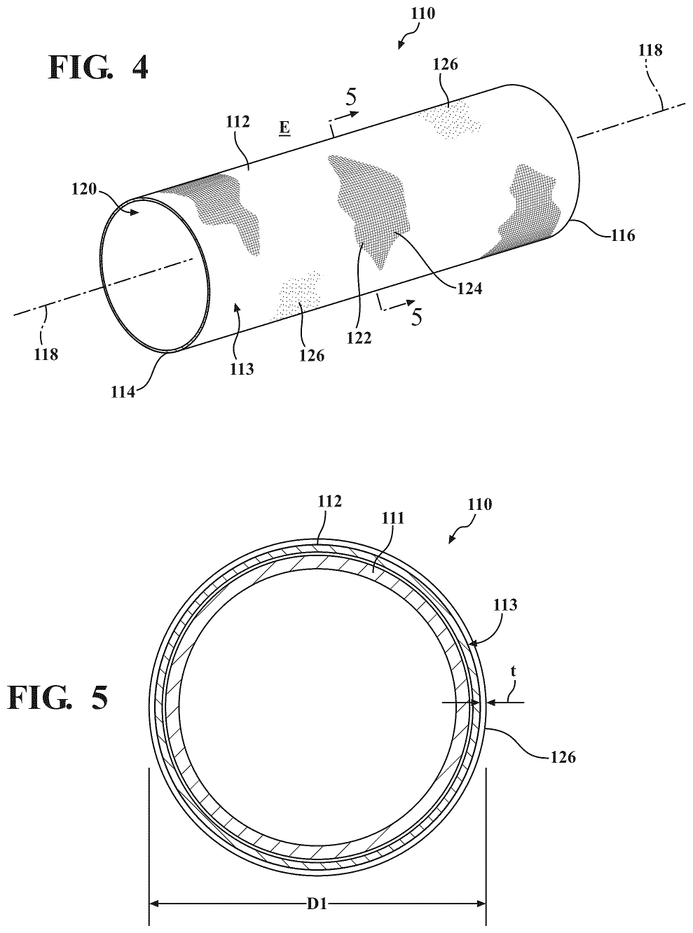

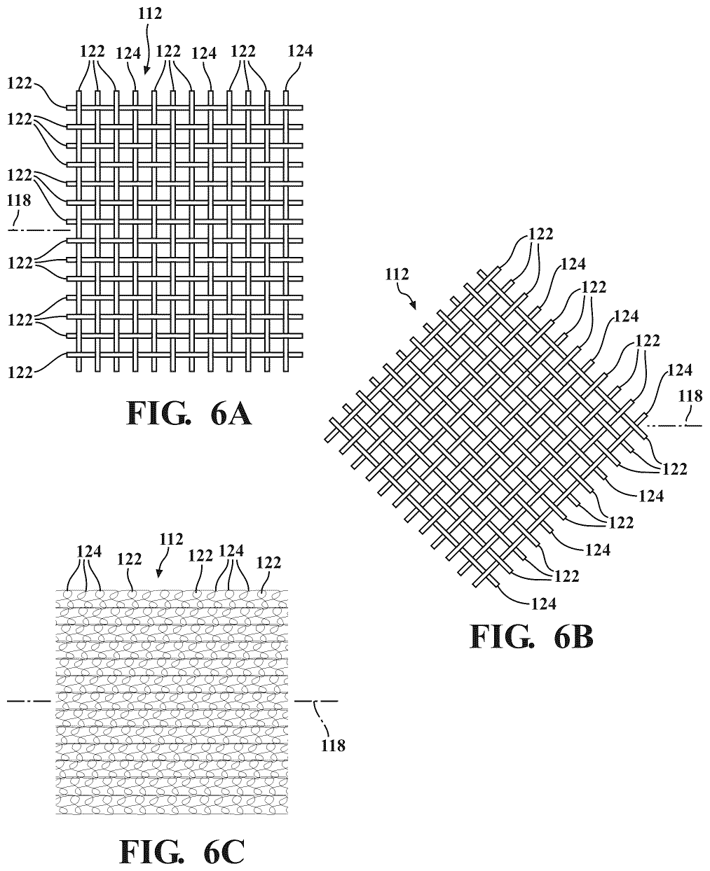

Referring in more detail to the drawings, FIGS. 1 and 4 illustrate a protective textile sleeve, referred to hereafter as sleeve 10, 110, respectively, constructed in accordance with one aspect of the invention having a textile wall 12, 112 disposed about an elongate member to be protected, such as a bus-bar 11 interconnecting portions, such as adjacent cells and/or cell modules, and/or a fluid coolant conveying conduit 111 (FIG. 5) extending about an cooling the cells and/or cell modules, of a battery pack, referred to hereafter as battery B, of a vehicle, such as an electric vehicle EV, to one another. The textile wall 12, 112 has a seamless, circumferentially continuous outer surface 13, 113 that extends lengthwise between open opposite ends 14, 16; 114, 116 and about a longitudinal central axis 18, 118 to bound a central cavity 20, 120. The elongate member 11, 111 extends through and is protected in the central cavity 20, 120 against impact forces by the textile wall 12, 112, such as may be experienced in a vehicle crash, abrasion, and ingress of contamination, by way of example and without limitation. The textile wall 12, 112 alone suppresses flame propagation, such as in the event of thermal runaway of one or more of the cells of the battery B, thereby allowing the electric vehicle EV to remain powered by the battery for 5 minutes or more when exposed to heat of about 1200° C. to allow the electric vehicle EV to be safely driven to a parked location, whereat the operator can evacuate the electric vehicle EV. The textile wall 12, 112 is formed at least in part or entirely of flame-resistant multifilament yarn 22, 122, and can be knit (FIG. 6C) to maximize elasticity and stretchability of the wall 12 to facilitate assembly of the sleeve 10, 110 about the elongate member 11, 111. The textile wall 12, 112 can also be braided (FIG. 6B), wherein elasticity and stretchability of the wall 12, 112 remains, but to a lesser extent than if knit, or the textile wall 12, 112 can be woven (FIG. 6A), wherein elasticity and stretchability of the wall 12, 112 is less than if knit or braided. The textile wall 12, 112 has a non-bulky low profile, and is aesthetically appealing. Accordingly, the textile structure of the textile wall 12, 112 is stretchable axially and radially (circumferentially), particularly if knit, thereby allowing the knit wall 12, 112 to flex and be easily assembled into close, snug fitting relation about the bus-bar 11 or fluid conveying conduit 111.

The textile wall 12, 112 can be formed having a single layer or a plurality of layers arranged in overlying relation with one another. If formed having a plurality of layers, the plurality of layers can be connected to one another, such that the layers are inseparable from one another. The plurality of layers can be formed in a continuous interlacing operation, and can further be made including different yarn types from one another to provide the separate layers having different protective properties from one another.

To further enhance the flame resistance and thermal insulation properties of the sleeve 10, 110, while maintaining the aforementioned axial and radial stretchability, while also enhancing the protective properties against ingress of contamination and preventing leaking of any coolant fluids, an impervious layer, also referred to as impervious coating 26, 126, is provided to extend about the outer surface 13, 113 of the textile wall 12, 112 to prevent the ingress and penetration of dust, particles, smoke through the textile wall 12, 112, and to enhance the flame resistance and flame protection of the sleeve 10, 110. The impervious coating 26, 126 is elastically stretchable in all directions, including the lengthwise and radial directions, to allow the underlying textile wall 12, 112 to remain stretchable along the lengthwise and radial directions, and is elastically resilient, thereby facilitating the formation of a wrinkle-free, snug conforming fit of the textile wall 12, 112, and ultimately the sleeve 10, 110, about the bus-bar 11 and/or conduit 111. In accordance with a further aspect of the disclosure, a heat-shrinkable yarn 124 can be included to allow the entirety of the sleeve 10, 110 to be heat-shrunk about the elongate member 11, 111 into a close, snug fit therewith.

Importantly, the impervious coating 26, 126 includes one of a silicone ingredient, also referred to as material, a silicone-based ingredient, a liquid silicone rubber ingredient, a polytetrafluoroethylene ingredient, or a polyurethane ingredient. To further enhance flame and heat resistance properties of the sleeve 10, 110, regardless of which ingredient is used for the impervious coating 26, 126, the impervious coating 26, 126 includes at least one of carbon black pigmentation and/or iron oxide and/or a blue pigmentation and/or other dark pigmentation making up between 0.01-10.0% by weight content of the impervious coating 26, 126. To further yet enhance flame and heat resistance properties of the sleeve 10, 110, the impervious coating 26, 126 includes a fire retardant, such zinc borate, that makes up between about 1.0-20.0% by weight content of the impervious coating 26, 126. In one non-limiting exemplary embodiment, the impervious coating 26, 126 has a content of silicone making up between 80.0-99.0% by weight content of the impervious coating 26, 126. The impervious coating 26, 126 can be provided as a single layer applied and bonded to the outer surface 13, 113, with the coating, also referred to as layer 26, 126, being bonded directly to the outer surface 13, 113. The impervious layer 26, 126 can be applied to the outer surface 13, 113 using any desired process that allows the desired thickness (t) of the layer 26, 126 to be attained. In the exemplary embodiment, the thickness t is between about 0.1-10 mm, and preferably between about 0.1 and 1.0 mm, and more preferably between about 0.1 and 0.5 mm. When the layer 26, 126 is provided within the aforementioned range of thickness t, flexibility and conformability of the wall 12, 112 is optimized.

The impervious coating 26, 126 can be formed as a single layer having the aforementioned thickness (t). The impervious coating 26, 126 can further be formed as a plurality of overlying layers, with each layer having a thickness between 0.1-10 mm. Whether provided as a single layer or a plurality of layers, each layer of impervious coating 26, 126 is separately cured from one another to attain a uniform curing throughout the individual layers, thereby maximizing the protective properties of the individual layer(s) 26, 126. Curing each layer of the impervious coating 26, 126 is performed over a temperature range of about 100-300° C. for a duration between about 1-30 min. The impervious coating 26, 126, due in large part to the carbon black and/or iron oxide constituent ingredients, provides enhance protection against flame and heat of 1000° C. or more to the elongate member 11, 111, thereby providing increased levels of thermal insulation protection to the elongate member 11, 111, thus, allowing the elongate member 11, 111 to continue functioning as intended for an extended period of time, such as up to 20 min or more at the extreme temperature of 1000° C. or higher. In the case where the elongate member 111 is a coolant conduit, the enhanced thermal protection protects the coolant again boiling and evaporation for the extended period of functionality.

In accordance with another aspect of the invention, in view of the synergistic relationship discovered for the following, the sleeve 10, 110 can consist of (meaning no additional features/elements are to be included other than those discussed here) the textile wall 12, 112 having a circumferentially continuous outer surface 13, 113 extending along a longitudinal axis 18, 118 between opposite open ends 14, 16; 114, 116. The textile wall 12, 112 can be formed entirely of multifilament flame-resistant yarn, as discussed above, or optionally, as also discussed above, can include a heat-shrinkable yarn 124, such as only in a circumferential weft direction if woven, or as one of the filaments, if braided or knitted, to allow the entirety of the sleeve 10, 110 to be heat-shrunk about the elongate member 11, 111 into a close, snug fit therewith. An impervious coating 26, 126 extends entirely about, and is bonded to the circumferentially continuous outer surface of the textile wall 12, 112. The impervious coating 26, 126 includes one of a silicone ingredient, a silicone-based ingredient, a liquid silicone rubber ingredient, a polytetrafluoroethylene ingredient, or a polyurethane ingredient, and further, the impervious coating 26, 126, and regardless of the aforementioned ingredient selected, to further enhance flame-resistance, includes at least one of carbon black pigmentation impregnated therein and iron oxide pigmentation impregnated therein.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A sleeve for protecting an elongate member, comprising:
a textile wall having a circumferentially continuous outer surface extending along a longitudinal axis between opposite open ends, said textile wall being formed at least in part by multifilament flame-resistant yarn; and
an impervious coating extending about said circumferentially continuous outer surface of said textile wall, said impervious coating including one of a silicone ingredient, silicone-based ingredient, liquid silicone rubber ingredient, polytetrafluoroethylene ingredient, or polyurethane ingredient,
wherein said impervious coating includes at least one of a carbon black pigmentation and an iron oxide pigmentation impregnated therein.

2. The sleeve of claim 1, wherein said impervious coating includes a fire retardant.

3. The sleeve of claim 2, wherein said carbon black pigmentation and/or said iron oxide pigmentation make up between 0.01-10.0% by weight content of said impervious coating.

4. The sleeve of claim 3, wherein said fire retardant makes up between 1.0-20.0% by weight content of said impervious coating.

5. The sleeve of claim 4, wherein the content of the silicone in said impervious coating is between 80.0-99.0% by weight content of said impervious coating.

6. The sleeve of claim 1, wherein said impervious coating is a single layer having a thickness between 0.1-10 mm.

7. The sleeve of claim 1, wherein said impervious coating includes a plurality of separately formed layers, with each layer has a thickness between 0.1-10 mm.

8. The sleeve of claim 7, wherein said layers of the impervious coating are cured separately from one another.

9. The sleeve of claim 8, wherein said layers are cured over a temperature range of about 100-300° C. for a duration between about 1-30 min.

10. The sleeve of claim 1, wherein said multifilament flame-resistant yarn is a mineral yarn.

11. The sleeve of claim 10, wherein said mineral yarn is at least one of fiberglass, silica, and basalt.

12. The sleeve of claim 10, wherein said textile wall is formed entirely of said mineral yarn.

13. The sleeve of claim 1, wherein said textile wall is configured to be disposed about a bus-bar or fluid conveying conduit of a battery pack of an electric vehicle.

14. A sleeve for protecting an elongate member, consisting of:
a textile wall having a circumferentially continuous outer surface extending along a longitudinal axis between opposite open ends, said textile wall being formed at least in part by multifilament flame-resistant yarn; and
an impervious coating extending about said circumferentially continuous outer surface of said textile wall, said impervious coating being one of a silicone ingredient, silicone-based ingredient, liquid silicone rubber ingredient, polytetrafluoroethylene ingredient, or polyurethane ingredient,
wherein said impervious coating includes at least one of carbon black pigmentation impregnated therein and iron oxide pigmentation impregnated therein.

15. The sleeve of claim 14, wherein said carbon black pigmentation and/or said iron oxide pigmentation make up between 0.01-10.0% by weight content of said impervious coating.

16. The sleeve of claim 15, wherein the content of the silicone in said impervious coating is between 80.0-99.0% by weight content of said impervious coating.

17. The sleeve of claim 16, wherein said impervious coating includes a fire retardant.

18. The sleeve of claim 17, wherein said fire retardant makes up between 1.0-20.0% by weight content of said impervious coating.

19. The sleeve of claim 14, wherein said impervious coating is a single layer having a thickness between 0.1-10 mm.

20. The sleeve of claim 14, wherein said impervious coating includes a plurality of separately formed layers, with each layer has a thickness between 0.1-10 mm.
